(19) United States
(12) Patent Application Publication
(10) Pub. No.: US 2018/0365998 A1
(43) Pub. Date: Dec. 20, 2018

(54) DRIVING ASSISTANCE APPARATUS

(71) Applicant: MITSUBISHI ELECTRIC CORPORATION, Tokyo (JP)

(72) Inventors: Hiroyoshi SHIBATA, Tokyo (JP); Hisashi SUGAWARA, Tokyo (JP)

(73) Assignee: MITSUBISHI ELECTRIC CORPORATION, Tokyo (JP)

(21) Appl. No.: 15/735,673

(22) PCT Filed: Jul. 28, 2015
(86) PCT No.: PCT/JP2015/071364

§ 371 Date: Dec. 12, 2017

(51) Int. Cl. G08G 1/16

(52) U.S. Cl. CPC G08G 1/16

(57) ABSTRACT

In a driving assistance apparatus, a driving condition estimator estimates the condition of a driver in a host vehicle and generates driving condition information. A risk information generator detects risky behavior taken by the driver, and generates risk information in which a risky point at which the risky behavior is detected is associated with driving condition information that is generated by the driving condition estimator in a prescribed zone located back from the risky point in a traveling direction, for recordation of the risk information into a server. A presentation determination unit compares driving condition information generated by the driving condition estimator in the prescribed zone located back in a traveling direction from a risky point of the risk information, with driving condition information included in the risk information received from the server, thereby to determine whether to present the risk information.

### TECHNICAL FIELD

The invention relates to a driving assistance apparatus for presenting, to a driver, information on locations at which attention should be paid to driving of a vehicle.

### BACKGROUND ART

Frightening and surprising (near miss) behaviors in road traffic are risky behaviors which may not actually result in accidents but “frighten” or “surprise” drivers in the driving of vehicles. In order to share a risky point where a driver in a certain vehicle has taken risky behavior, with drivers in other vehicles, conventionally, there are devices that automatically detect risky behavior such as sudden braking, from the behavior of a traveling vehicle, collect the detected behavior as risk information, and transmit the risk information to other vehicles. However, there is the problem that it is troublesome for drivers who are driving safely when all pieces of the collected risk information are transmitted for presentation to the drivers of other vehicles.

To address this problem, for example an information providing apparatus according to Patent Literature 1 discriminates between when specific attention is required and when normal attention is required, in accordance with the traveling direction of a vehicle in a specific area on a specific road such as an intersection, thus switching between the presentation and non-presentation of risk information.

### CITATION LIST

### Patent Literatures

Patent Literature 1: Japanese Patent Application Publication No. 2012-243165.

### SUMMARY OF INVENTION

### Technical Problem

There are various causes for driver's risky behavior, including not only dependence on a situation at a certain point, but also the physical or mental fatigue of drivers while the drivers are traveling on a route to a certain point or on a route beyond the certain point, or carelessness due to familiarity with the routes. However, in the information providing device according to the aforementioned Patent Literature 1, since the conditions of drivers while traveling on a route before reaching the certain point or the route beyond the certain point are not taken into consideration, a problem arises where whether to present risk information cannot be determined with high accuracy.

The invention has been made in order to solve the above problem, and it is an object of the invention to determine whether to present risk information with high accuracy.

### Solution to Problem

A driving assistance apparatus according to the invention includes: a driving condition estimator configured to estimate a condition of a driver in a host vehicle to generate driving condition information; a risk information generator configured to detect risky behavior taken by the driver, and configured to generate risk information in which a risky point at which the risky behavior is detected is associated with driving condition information that is generated by the driving condition estimator in at least one of a prescribed zone located back from the risky point in a traveling direction and a prescribed zone located beyond the risky point in a traveling direction; a communication unit configured to transmit the risk information generated by the risk information generator to a server, and to receive, from the server, risk information indicating a risky point on a route on which the host vehicle is planned to travel; and a presentation determination unit configured to compare driving condition information, of the risk information received by the communication unit, generated by the driving condition estimator in at least one of a prescribed zone located back from a risky point in a traveling direction and a prescribed zone located beyond the risky point in a traveling direction, with driving condition information included in the risk information, thereby to determine whether to present the risk information.

### Advantageous Effects of Invention

According to the invention, whether to present risk information is determined on the basis of the condition of a driver in the host vehicle in at least one of a prescribed zone located back from a risky point in a traveling direction and a prescribed zone beyond the risky point in a traveling direction. Thus, whether to present the risk information can be determined with high accuracy.

### BRIEF DESCRIPTION OF DRAWINGS

FIG. 1 is a block diagram illustrating an exemplary configuration of a driving assistance system using a driving assistance apparatus according to a first embodiment of the invention.

FIG. 2 is a diagram illustrating an exemplary hardware configuration of the driving assistance apparatus according to the first embodiment.

FIG. 3 is a diagram for explaining a method of estimating a fatigue level of a driver in the driving assistance apparatus according to the first embodiment, and plots a fatigue curve.

FIG. 4 is a diagram for explaining a method of estimating a fatigue level of a driver in the driving assistance apparatus according to the first embodiment, and plots a recovery curve.

FIG. 5 is a diagram for explaining a method of correcting the fatigue level in accordance with driving operation in the driving assistance apparatus according to the first embodiment.

FIG. 6 is a diagram for explaining a method of correcting the fatigue level in accordance with the road type in the driving assistance apparatus according to the first embodiment.

FIG. 7 is a diagram for explaining a method of correcting the fatigue level in accordance with biological information of a driver or vehicle information of a host vehicle in the driving assistance apparatus according to the first embodiment.

FIG. 8 is a diagram for explaining a method of correcting a fatigue recovery level in accordance with biological information of a driver in the driving assistance apparatus according to the first embodiment.

FIG. 9 is a diagram illustrating driving operation and additional values used for correcting the fatigue level in the driving assistance apparatus according to the first embodiment.

FIGS. 10A to 10C are diagrams illustrating the type and weights of roads used for correcting the fatigue level in the driving assistance apparatus according to the first embodiment.

FIG. 11 is a diagram illustrating characteristic conditions of a driver or a host vehicle used for correcting the fatigue level in the driving assistance apparatus according to the first embodiment.

FIG. 12 is a diagram illustrating the type and weights of destinations used for correcting the fatigue level in the driving assistance apparatus according to first embodiment.

FIG. 13 is a flowchart illustrating processing for recordation of risk information in the driving assistance apparatus according to the first embodiment.

FIG. 14 is a flowchart illustrating processing for presentation of risk information in the driving assistance apparatus according to the first embodiment.

FIG. 15 is a graph for explaining the processing for presentation of risk information in the driving assistance apparatus according to the first embodiment.

FIG. 16 is a diagram illustrating the number of times of traveling used for presentation determination of risk information in the driving assistance apparatus according to the first embodiment.

FIG. 17 is a flowchart illustrating processing for presentation of risk information in a driving assistance apparatus according to a second embodiment of the invention.

FIG. 18 is a graph for explaining the processing for presentation of risk information in the driving assistance apparatus according to the second embodiment.

FIG. 19 is a flowchart illustrating processing for presentation of risk information in a driving assistance apparatus according to a third embodiment of the invention.

FIG. 20 is a graph for explaining the processing for presentation of risk information in the driving assistance apparatus according to the third embodiment.

### DESCRIPTION OF EMBODIMENTS

To describe the invention further in detail, embodiments for carrying out the invention will be described below with reference to the accompanying drawings.

### First Embodiment

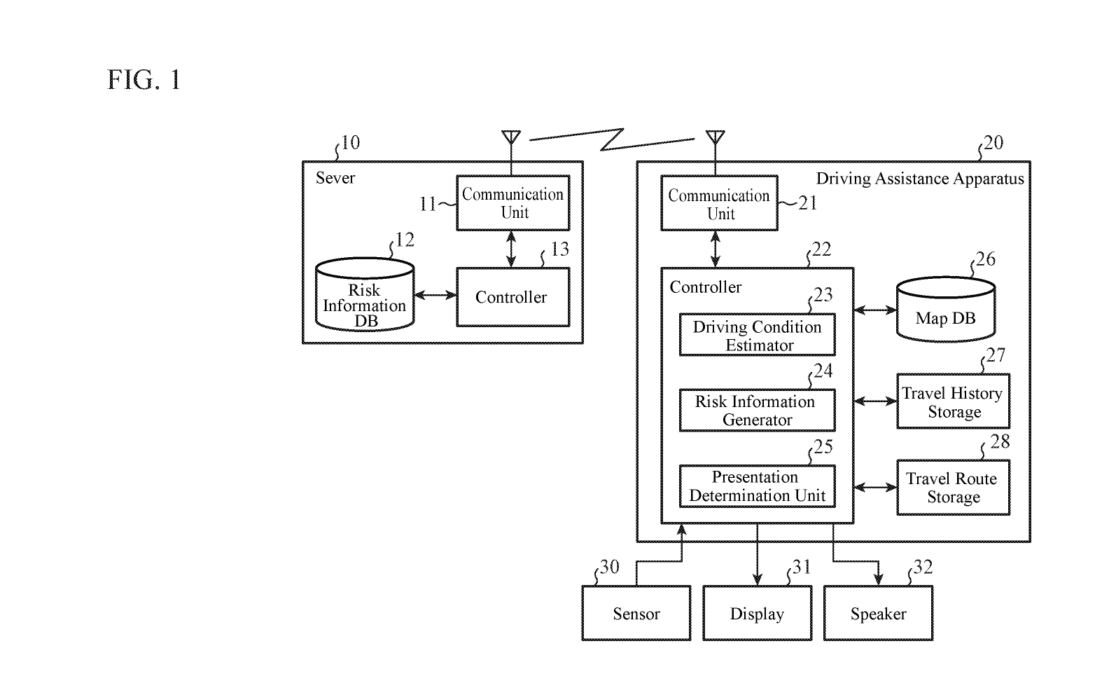

FIG. 1 is a block diagram illustrating an exemplary configuration of a driving assistance system using a driving assistance apparatus 20 according to a first embodiment of the invention. The driving assistance system includes a server 10 and a plurality of driving assistance apparatuses 20 mounted on a plurality of vehicles. The server 10 and each of the driving assistance apparatuses 20 are capable of wireless communication by a network such as Wi-Fi, 3G, or 4G.

The server 10 includes a communication unit 11 for transmitting and receiving risk information by performing wireless communication with the driving assistance apparatuses 20, a risk information database (DB) 12 for storing risk information, and a controller 13 for recording the risk information received from the driving assistance apparatuses 20 via the communication unit 11 in the risk information DB 12 and transmitting risk information recorded in the risk information DB 12 to one of the driving assistance apparatuses 20 via the communication unit 11.

The driving assistance apparatus 20 includes a communication unit 21 for transmitting and receiving risk information by performing wireless communication with the server 10, a controller 22 for determining whether to generate risk information to be transmitted to the server 10 and to present risk information received by the server 10, a map DB 26 for storing map information, a travel history storage 27 for storing travel history information on travel history of a host vehicle, and a travel route storage 28 for storing travel route information related to a route on which the host vehicle is planned to travel.

The controller 22 includes: a driving condition estimator 23 configured to estimate the condition of a driver in the host vehicle, and to generate driving condition information; a risk information generator 24 configured to detect risky behavior taken by the driver and to generate risk information in which a risky point at which the risky behavior is detected is associated with the driving condition information that is generated by the driving condition estimator 23 in a prescribed zone located back from the risky point in a traveling direction; and a presentation determination unit 25 configured to compare the driving condition information, of the risk information received from the server 10 via the communication unit 21, generated by the driving condition estimator 23 in the prescribed zone located back from the risky point, with the driving condition information included in the risk information, thereby to determine whether to present the risk information.

In the first embodiment, the prescribed zone located back from a risky point in the traveling direction is a zone that includes: a route starting from a starting position to a risky point on a route on which a host vehicle travels; a route starting from an area including a starting position (for example, an area within a radius of 1 km including the starting position), to a risky point; or a route starting from a risky point on a route on which the host vehicle travels, to a point located a predetermined distance (for example, 10 km) back from the risky point in the traveling direction.

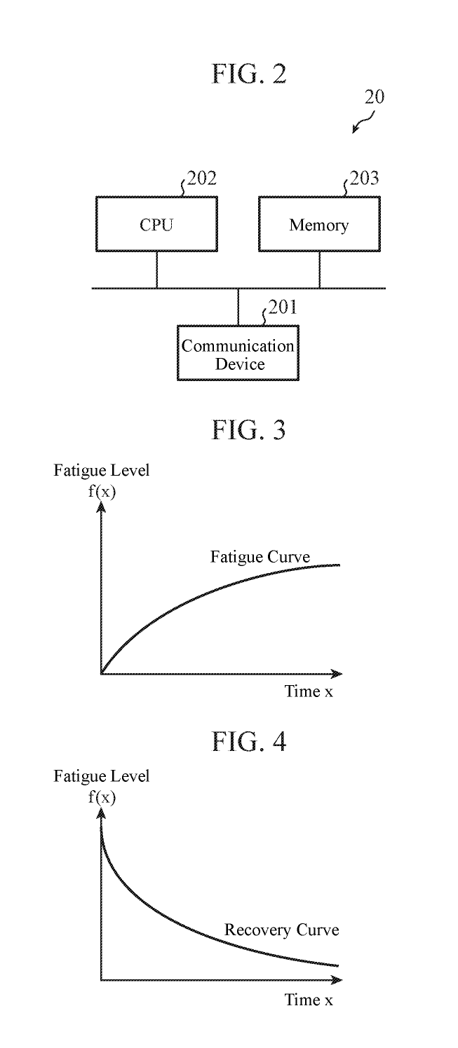

FIG. 2 is a diagram illustrating an exemplary hardware configuration of the driving assistance apparatus 20 according to the first embodiment.

As illustrated in FIG. 2, the communication unit 21 in the driving assistance apparatus 20 corresponds to a communication device 201 that performs wireless communication using a network such as Wi-Fi, 3G, or 4G. The map DB 26, the travel history storage 27, and the travel route storage 28 in the driving assistance apparatus 20 correspond to a memory 203. Functions of the driving condition estimator 23, the risk information generator 24, and the presentation determination unit 25 in the driving assistance apparatus 20 are implemented by a processing circuit. Specifically, the driving assistance apparatus 20 includes a processing circuit for generating risk information indicating risky behavior taken by a driver in the host vehicle and transmitting the risk information to the server 10, and receiving risk information from the server 10 and presenting the risk information by a display 31 or a speaker 32. The processing circuit is a CPU (Central Processing Unit) 202 that executes a program stored in the memory 203.

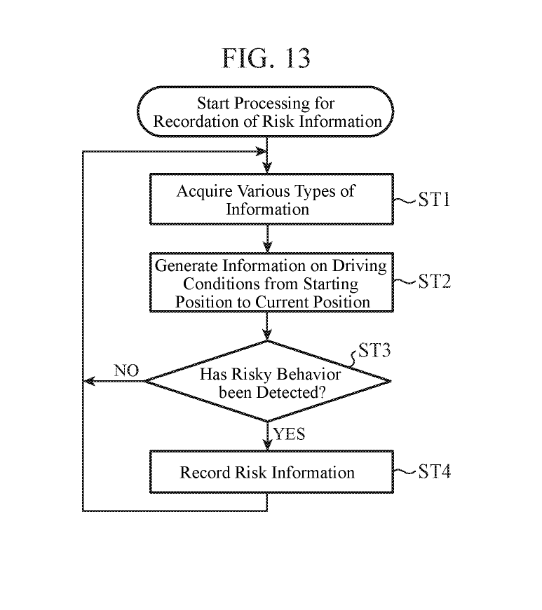

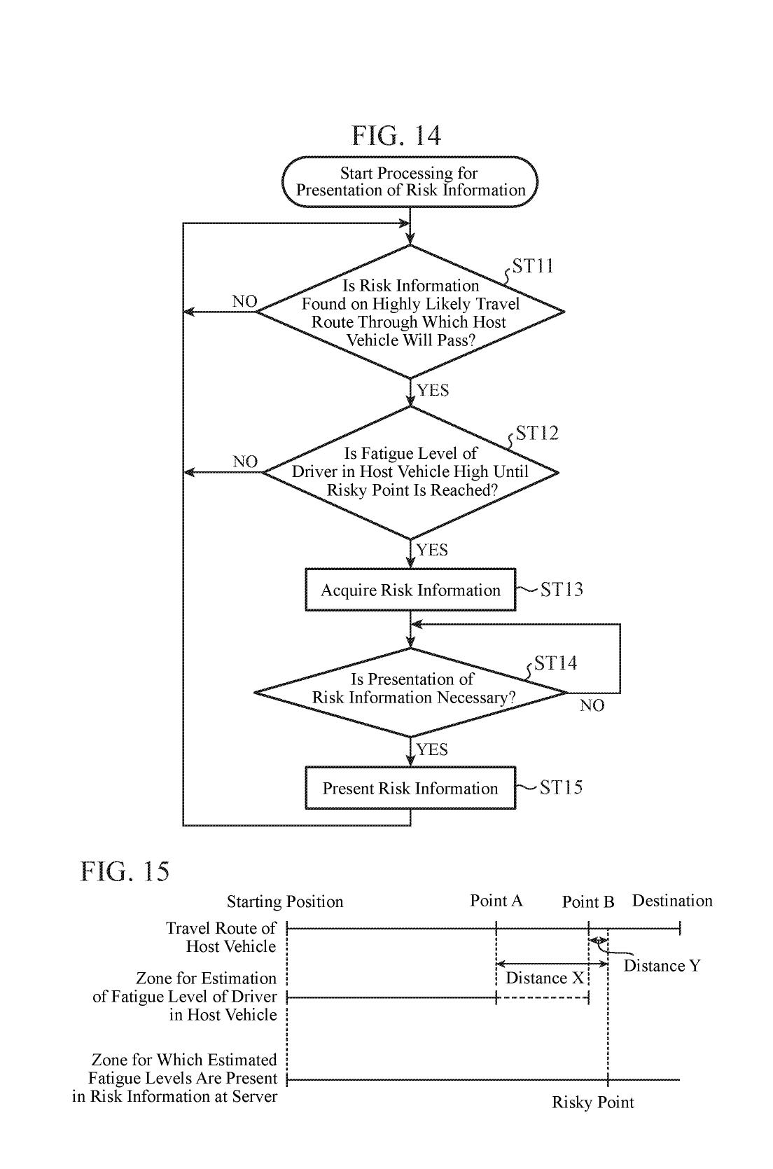

The functions of the driving condition estimator 23, the risk information generator 24, and the presentation determination unit 25 are implemented by software, firmware, or a combination of software and firmware. Software or firmware is described as a program and stored in a memory 203. The CPU 202 reads and executes the program stored in the memory 203 and thereby implements functions of the units. Specifically, the driving assistance apparatus 20 includes the memory 203 for storing a program to be executed as a result of respective steps illustrated in FIG. 13 and FIG. 14 described later when the program is executed by the CPU 202. It can also be regarded that this program causes a computer to execute a procedure or a method of the driving condition estimator 23, the risk information generator 24, and the presentation determination unit 25.

Here, the CPU 202 may include, for example, a central processing unit, a processing unit, an arithmetic unit, a processor, a microprocessor, a microcomputer, a digital signal processor (DSP), or the like.

The memory 203 may be a nonvolatile or volatile semiconductor memory such as a random access memory (RAM), a read only memory (ROM), a flash memory, an erasable programmable ROM (EPROM), an electrically EPROM (EEPROM), a magnetic disk such as a hard disk or a flexible disk, or an optical disk such as a mini disk, a compact disc (CD) or a digital versatile disc (DVD).

A sensor 30 installed in the host vehicle is connected to the driving assistance apparatus 20.

The sensor 30 may be, for example, a sensor for detecting the state of the host vehicle, a sensor for detecting the condition of a driver in the host vehicle, or other sensors.

Examples of a sensor for detecting the state of the host vehicle include a GPS (Global Positioning System) sensor for detecting the current location of the host vehicle, a speed sensor for detecting the speed of the host vehicle, a sensor for detecting the operation amount of a steering wheel, a sensor for detecting the operation amount of a brake, and OBD (On-Board Diagnosis). Information indicating the state of the host vehicle detected by these sensors is referred to as “vehicle information”.

Examples of a sensor for detecting the condition of a driver includes a sensor for detecting a heartbeat, a blood pressure, or a body temperature, an image recognition device for imaging a driver and recognizing an image, a speech recognition device for acquiring and recognizing uttered speech of a driver, or other devices. Information indicating the condition of a driver detected by these sensors is referred to as “biological information”.

Vehicle information and biological information detected by the sensor 30 are input to the driving assistance apparatus 20.

At least one of the display 31 and the speaker 32 installed in the host vehicle is connected to the driving assistance apparatus 20 as a presentation device for presenting risk information.

In the driving assistance apparatus 20, the driving condition estimator 23 estimates the condition of the driver on the basis of vehicle information or biological information received from the sensor 30, and generates driving condition information. The condition of the driver mainly includes a fatigue level of the driver, and the driving condition information indicates a numerical value of the fatigue level of the driver.

Hereinafter, a method of generating the driving condition information will be described with reference to FIGS. 3 to 12. It is assumed that information illustrated in FIGS. 9 to 12 is defined in advance and set in the driving condition estimator 23.

For example, the driving condition estimator 23 estimates a duration of driving time of the host vehicle, on the basis of time information contained in GPS information of the sensor 30, vehicle-speed information, information indicating a position of a shift lever, and other information, and estimates a fatigue level such that the estimated fatigue level becomes higher as the duration of driving time becomes longer.

FIG. 3 is a diagram for explaining a method of estimating a fatigue level of a driver in the driving assistance apparatus 20 according to the first embodiment, and plots a fatigue curve. The fatigue level of the driver is defined as f(x)=α√x, where, α>0 holds, and x denotes time. The fatigue level rises non-linearly as time duration of driving by the driver becomes longer.

FIG. 4 is a diagram for explaining a method of estimating a fatigue level of a driver in the driving assistance apparatus 20 according to the first embodiment, and plots a recovery curve. The fatigue recovery level of the driver is defined as f(x)=β√x, where, β<0 holds, and x denotes time. The fatigue level decreases non-linearly as the driver stops a vehicle and time of interruption of driving becomes longer.

By using the fatigue curve and the recovery curve illustrated in FIGS. 3 and 4, the driving condition estimator 23 estimates the fatigue level of the driver traveling a certain zone.

Furthermore, the driving condition estimator 23 may correct the fatigue level of the driver estimated on the basis of the duration of driving time in consideration of other factors. As a correction method, at least one of a method using driving operation performed in a certain zone, a method using biological information or vehicle information detected in a certain zone, a method using the road type in a certain zone, and a method using the type of destination is to be employed.

For example, the driving condition estimator 23 determines driving operation on the basis of vehicle information of the sensor 30, adds an additional value corresponding to the driving operation to the fatigue level, and thereby corrects the fatigue level.

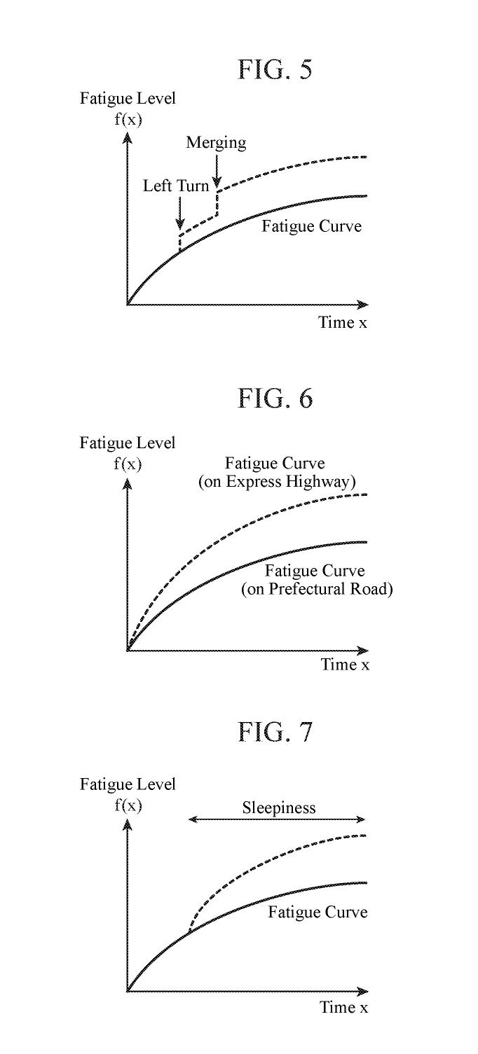

FIG. 5 is a diagram for explaining a method of correcting the fatigue level in accordance with driving operation in the driving assistance apparatus 20 according to the first embodiment. A solid line is a fatigue curve indicating the fatigue level before correction, and a broken line is a fatigue curve indicating the fatigue level after correction in accordance with driving operation.

FIG. 9 is a diagram illustrating driving operation and additional values used for correcting the fatigue level. When the driver performs driving operation illustrated in FIG. 9, fatigue corresponding to the content of the driving operation is considered to accumulate. Therefore, the driving condition estimator 23 corrects the fatigue level on the basis of the driving operation and additional values in FIG. 9 for example by adding “+1” to the fatigue level when the driver turns right once or by adding “+2” to the fatigue level when the driver joins from a road being traveled to another road. Note that the driving condition estimator 23 may determine whether driving operation such as merging has been performed using not only vehicle information of the sensor 30 but also the map information of the map DB 26.

Furthermore, for example, the driving condition estimator 23 determines the road type on the basis of GPS information which is the vehicle information of the sensor 30 and the map information of the map DB 26, performs weighting in accordance with the road type, and thereby corrects the fatigue level.

FIG. 6 is a diagram for explaining a method of correcting the fatigue level in accordance with the road type in the driving assistance apparatus 20 according to the first embodiment. A solid line is a fatigue curve indicating the fatigue level with a weight of “1.0”, that is, the same fatigue level as that before correction, and a broken line is a fatigue curve indicating the fatigue level after correction with a weight of “1.2”

FIGS. 10A to 10C are diagrams illustrating the type and weights of roads used for correcting the fatigue level. As the road type, classifications of a road are illustrated in FIG. 10A, the number of lanes are illustrated in FIG. 10B, and examples of the road width are illustrated in FIG. 10C. Depending on the road type being traveled on, the degree of accumulation of fatigue levels of a driver is considered to be different. Therefore, on the basis of the road type and weights in FIGS. 10A to 10C, the driving condition estimator 23 performs weighting correction such that the fatigue level becomes high when an express highway is traveled on than when a prefectural road is being traveled on, for example.

Furthermore, for example, the driving condition estimator 23 detects the characteristic condition of the host vehicle or driver on the basis of the vehicle information or the biological information of the sensor 30 and performs weighting correction of the fatigue level while the characteristic condition is detected.

FIG. 7 is a diagram for explaining a method of correcting the fatigue level in accordance with biological information of a driver or vehicle information of the host vehicle in the driving assistance apparatus 20 according to the first embodiment. A solid line is a fatigue curve indicating the fatigue level before correction, and a broken line is a fatigue curve indicating the fatigue level after correction in accordance with a characteristic condition of the driver (e.g. sleepiness).

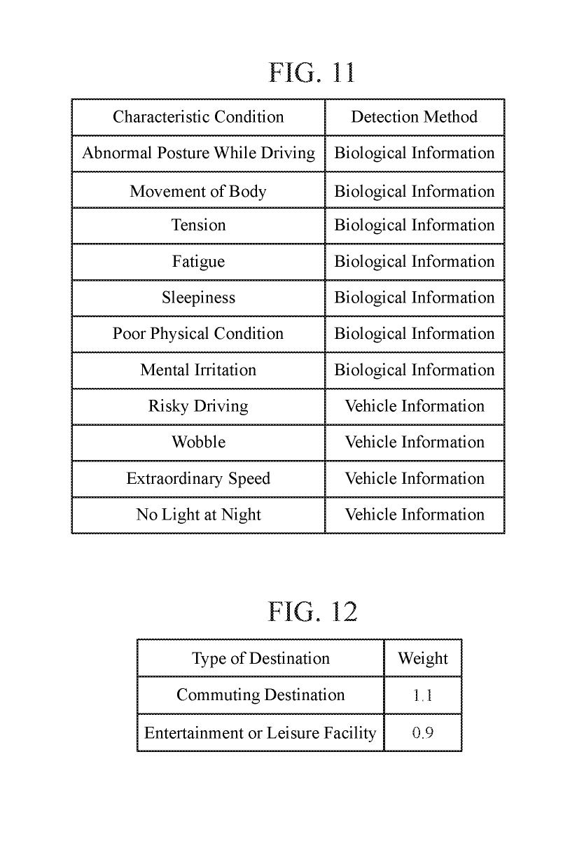

FIG. 11 is a diagram illustrating characteristic conditions of a driver or host vehicle, used for correcting the fatigue level. For example, in a case where a characteristic condition such as an abnormal posture while driving, movement of body not related to driving, tension, fatigue, sleepiness, poor physical condition, or mental irritation is detected on the basis of the driver's heartbeat, blood pressure, body temperature, a captured image, or uttered speech, which is biological information from the sensor 30, the driver is considered to be in a state of feeling fatigue or a state not concentrated on driving. Furthermore, in a case where a characteristic condition such as risky driving, wobble, extraordinary speed, or no light at night is detected on the basis of the vehicle speed, the operation amount of a steering wheel, or the operation amount of a brake which is vehicle information from the sensor 30, the driver is considered to be in a state of being liable to fatigue or fatigue. When detecting a characteristic condition as illustrated in FIG. 11, the driving condition estimator 23 performs weighting correction such that the fatigue level becomes high. Note that a value of the weight may be different for each characteristic condition or may be the same.

Although not illustrated in the figure, weighting correction may be performed in accordance with not only the condition of the driver or host vehicle but also a surrounding condition. For example, since it is considered that the driver is more likely to be fatigued when traveling in a bad weather or in the nighttime rather than traveling in a fine weather or in the daytime, the driving condition estimator 23 performs weighting correction such that the fatigue level becomes high in a bad weather or in the nighttime.

Note that, although an example to correct the fatigue curve has been described in the above description, the recovery curve of fatigue can also be corrected.

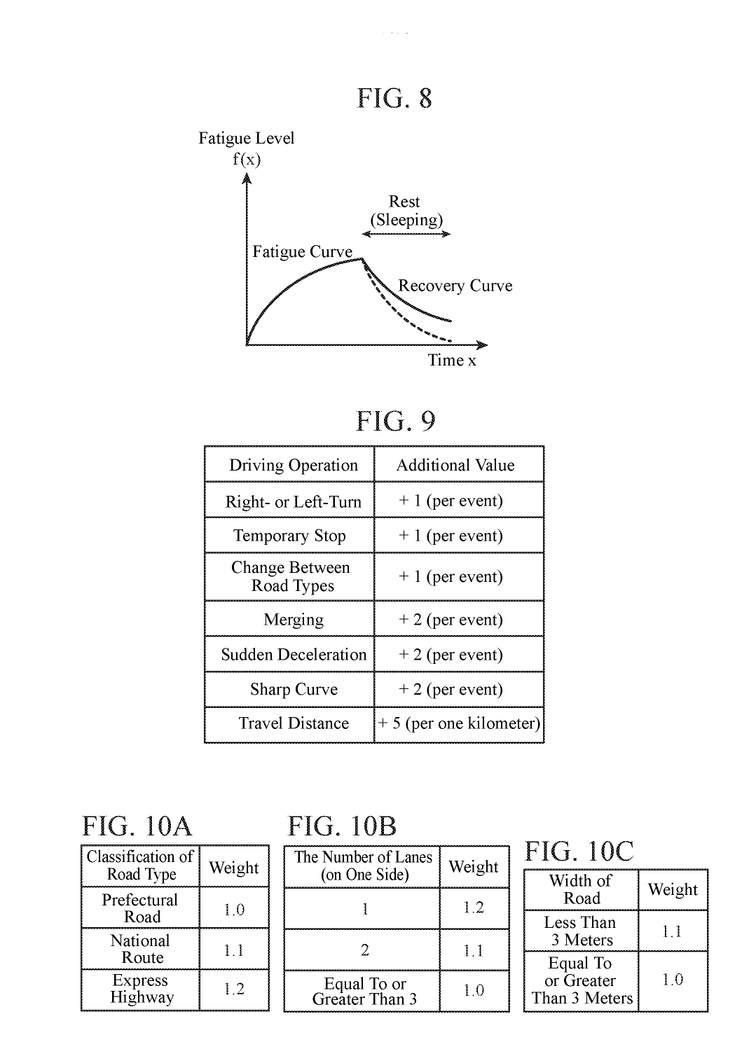

FIG. 8 is a diagram for explaining a method of correcting a fatigue recovery level in accordance with biological information of a driver in the driving assistance apparatus 20 according to the first embodiment. In FIG. 8 it is illustrated that, although the fatigue level of a driver increases with an elapse of a duration of driving time, recovery from fatigue is made by stopping driving and taking a break, and the fatigue level decreases. A solid line is a recovery curve indicating the recovery level of fatigue before correction, and a broken line is a recovery curve indicating the fatigue recovery level after correction in accordance with a characteristic condition of the driver (e.g. sleepiness).

Short sleeping in fifteen to thirty minutes, which is called a power nap, is particularly an effective way to recover from fatigue. Therefore, in a case where the host vehicle is stationary on the basis of the vehicle information from the sensor 30, when detecting a sleeping driver on the basis of the biological information from the sensor 30, the driving condition estimator 23 corrects the recovery curve by weighting thereby to accelerate recovery from fatigue.

Furthermore, the driving condition estimator 23 may change a weight value to accelerate the recovery under the assumption that sleeping is particularly an effective way to recovery from fatigue of drivers who usually have insufficient sleep. For example, the driving condition estimator 23 receives, from the driver, input of information indicating whether sleeping is usually insufficient, and changes a weight to be used for correction of recovery from fatigue.

Furthermore, the driving condition estimator 23 may correct the fatigue level of a driver in accordance with the type of destination of the host vehicle.

FIG. 12 is a diagram illustrating the type and weights of destinations used for correcting a fatigue level. In the example of FIG. 12, the type of destination includes two types of “commuting destination” and “entertainment or leisure facility”. There may be a difference in a psychological state during driving between the case of “commuting destination” and the case of “entertainment or leisure facility”. In this case, a large weight is set to “commuting destination” assuming that “commuting destination” provides more psychological burden and thus accelerates fatigue as compared to “entertainment or leisure facility”.

The driving condition estimator 23 acquires a destination of the host vehicle stored in the travel route storage 28 and estimates the type of the destination by a method which will be described later. When a destination of the host vehicle is not stored in the travel route storage 28, the driving condition estimator 23 may estimate a destination using the GPS information of the sensor 30 and travel history in the past stored in the travel history storage 27 and thereby estimate the type of the destination.

Here, a method of estimating the type of destination will be described. The driving condition estimator 23 refers to the travel history stored in the travel history storage 27 and to calendar information indicating a date and time when the travel history has been stored. In a case where a similar route is traveled on in the same time zone four or more times in a week, and staying time, which is a difference between arrival time of an outbound route at that time and departure time of a return route, is long (for example, three hours or more), the driving condition estimator 23 determines a destination of the route as a “commuting destination”. Then, in a case where a route currently traveled on is the same as the aforementioned route determined as a “commuting destination”, the driving condition estimator 23 estimates that the current destination is also a “commuting destination”. In other cases, the driving condition estimator 23 estimates that a destination is an “entertainment or leisure facility”.

The risk information generator 24 detects risky behavior taken by a driver in the host vehicle, on the basis of vehicle information received from the sensor 30, and sets the current location of the host vehicle at which the risky behavior is detected, as a risky point. Risky behavior is, for example, sudden braking or sudden operation of a steering wheel, and the risk information generator 24 detects that risky behavior has been taken in a case where the vehicle information from the sensor 30 conforms to a predetermined condition.

The risk information generator 24 associates driving condition information generated by the driving condition estimator 23 in a prescribed zone located back in the traveling direction from a risky point where the risky behavior has been detected, with the risky point together with contents of the risky behavior, thereby generating risk information.

In this regard, in addition to the contents of the risky behavior, the risky point and the driving condition information, the risk information generator 24 may include, in the risk information, a date and time indicating when the risky behavior has been detected, an orientation indicating a traveling direction of the host vehicle at the time of detection of the risky behavior, a travel route of the host vehicle at the time of detection of the risky behavior, and the number of times when the host vehicle has traveled in the prescribed zone located back from a risky point in the traveling direction in the past, and other information. The risky point, the time and the orientation may be specified, by the risk information generator 24, on the basis of the GPS information of the sensor 30, the map information of the map DB 26, and other information. Furthermore, the current travel route and the number of times of traveling in the past may be acquired from the travel route storage 28 and the travel history storage 27 by the risk information generator 24.

The presentation determination unit 25 receives the risk information from the server 10 via the communication unit 21, and determines whether to present the risk information to the driver through the display 31 or the speaker 32 when the host vehicle approaches the risky point indicated by the risk information. In this case, if a fatigue level of the driving condition information indicated by the received risk information equals a fatigue level of the driving condition information that is generated by the driving condition estimator 23 in a prescribed zone located back from the risky point in the traveling direction indicated by the risk information, or if a fatigue level of the driving condition information generated by the driving condition estimator 23 is higher than a fatigue level of the driving condition information indicated by the received risk information, the presentation determination unit 25 determines presentation of this risk information. Namely, among drivers passing the risky point, only a driver whose fatigue level is estimated to be equal to or larger than the fatigue level included in the risk information is provided with the presentation of the risk information.

The map DB 26 stores map information including information such as classifications of road, the number of lanes, and the width of road. Note that in the illustrated example, the controller 22 is configured to use the map DB 26 included in the driving assistance apparatus 20; however without being limited to this configuration the controller 22 may use a map DB included in an in-vehicle device other than the driving assistance apparatus 20, a map DB existing on a network, or other map DB may be used.

The travel history storage 27 stores travel route information such as a travel route the host vehicle has traveled in the past, a date and time when the host vehicle has traveled on the travel route, time spent for traveling, and the number of times of traveling. For example, the controller 22 creates the travel history information using the GPS information from the sensor 30 or the like while the host vehicle is traveling, and stores the travel history information in the travel history storage 27.

The travel route storage 28 stores travel route information such as a travel route and a destination where there is a high possibility that the host vehicle will pass in the future. For example, the controller 22 may acquire the travel route information from a navigation device, accept input from the driver via an input device, or estimate using the current location and the travel history information of the host vehicle. When estimating a travel route that the host vehicle is likely to pass in the future in the controller 22, for example, the number of times of traveling for each route or road is calculated from travel history to estimate. In that case, since a plurality of candidates appears, a route having a high probability of being passed in the future is selected as a target from among them. Note that, as described above, the driving condition estimator 23 may estimate a destination.

Next, processing for recordation of risk information in the driving assistance apparatus 20 will be described.

FIG. 13 is a flowchart illustrating the processing for recordation of risk information in the driving assistance apparatus 20 according to the first embodiment. While the host vehicle is traveling, the driving assistance apparatus 20 repeatedly performs the processing as illustrated in a flowchart of FIG. 13.

In step ST1, the controller 22 receives vehicle information and living body information from the sensor 30, and outputs the both to the driving condition estimator 23 and the risk information generator 24.

In step ST2, the driving condition estimator 23 generates driving condition information on a travel route starting from a starting position to the current location using the vehicle information and the biological information from the sensor 30 received in step ST1.

In step ST3, the risk information generator 24 detects risky behavior such as a sudden braking or a sudden steering by using the vehicle information from the sensor 30 received in step ST1. When detecting the risky behavior (“YES” in step ST3), the risk information generator 24 proceeds to step ST4. On the other hand, if the risk information generator 24 does not detect risky behavior (“NO” in step ST3), the flow returns to step ST1.

In step ST4, the risk information generator 24 generates risk information including the contents of the detected risky behavior, a risky point indicating the current location at the time of detection of the risky behavior, the driving condition information generated by the driving condition estimator 23, and other information. This driving condition information indicates the estimated fatigue level of the driver obtained when the drivers travels on the route starting from the starting position to the risky point indicating the current location.

Then, the risk information generator 24 transmits the generated risk information to the server 10 via the communication unit 21. In the server 10, when the communication unit 11 receives the risk information from the driving assistance apparatus 20, the controller 13 records the risk information in the risk information DB12.

Next, processing for presentation of risk information in the driving assistance apparatus 20 will be described.

FIG. 14 is a flowchart illustrating the processing for presentation of risk information in the driving assistance apparatus 20 according to the first embodiment. While the host vehicle is traveling, the driving assistance apparatus 20 repeatedly performs the processing as illustrated in the flowchart of FIG. 14. It is assumed that, in addition to the processing as illustrated in the flowchart of FIG. 14, the driving assistance apparatus 20 generates the driving condition information as illustrated in FIG. 13 and records risk information.

FIG. 15 is a graph for explaining the processing for presentation of risk information in the driving assistance apparatus 20 according to the first embodiment, and illustrates, in order from top to bottom, a travel route of the host vehicle, a zone for estimation of the fatigue level of the driver in the host vehicle in the driving condition estimator 23, and a zone for which the estimated fatigue levels are present in risk information recorded in the server 10.

In step ST11, the presentation determination unit 25 accesses the server 10 via the communication unit 21, and determines whether risk information indicating a risky point on a highly likely travel route through which the host vehicle will pass in the future is recorded in the risk information DB12 at the server 10. Information on the highly likely travel route through which the host vehicle will pass in the future is stored in the travel route storage 28. In this regard, the presentation determination unit 25 may use, for determination of presentation, instead of the risk information indicating the risky point on the highly likely travel route through which the host vehicle will pass in the future, risk information indicating a risky point on a route similar to the travel route. The route similar to the travel route is, for example, a route having the same number of times of left- and/or right-turns as that of the travel route.

If the server 10 stores the recorded risk information that indicates the same traveling direction and indicates a risky point on the highly likely travel route through which the host vehicle will pass in the future (“YES” in step ST11), the presentation determination unit 25 proceeds to step ST12. On the other hand, if risk information conforming to the above conditions is not recorded in the server 10 (“NO” in step ST11), the presentation determination unit 25 executes step ST11 again.

In the example illustrated in FIG. 15, the presentation determination unit 25 determines whether the server 10 stores the recorded risk information that indicates a risky point on a travel route within a distance X (e.g. 10 km) beyond from a point A representing a reference in the traveling direction when the host vehicle is traveling at the point A. It is also assumed that risk information recorded in the server 10 includes driving condition information, indicating the estimated fatigue levels on a route starting from a starting position to a risky point.

Note that the timing at which the presentation determination unit 25 performs the operation of step ST11 may be, for example, periodic timing such as once in every 10 minutes during traveling, the timing at which an engine is turned on and driving is started, the timing at which a destination is set, or the timing at which a route scheduled to be traveled on is changed. This can be similarly applied to the timing of performing the operation of step ST21 as illustrated in FIG. 17 of a second embodiment described later and the timing of performing the operation of step ST31 as illustrated in FIG. 19 of a third embodiment.

In step ST12, the presentation determination unit 25 compares the driving condition information included in risk information conforming to the aforementioned conditions recorded in the server 10 with driving condition information generated by the driving condition estimator 23.

If a fatigue level of a driver in the host vehicle is higher than or equal to a fatigue level indicated by the risk information of the server 10 (“YES” in step ST12), the presentation determination unit 25 proceeds to step ST13 and acquires all information included in the risk information from the server 10. On the other hand, if a fatigue level of a driver in the host vehicle is less than the fatigue level indicated by the risk information of the server 10 (“NO” in step ST12), the presentation determination unit 25 returns to step ST11.

In the example illustrated in FIG. 15, in a case where the estimated fatigue level of the driver in the host vehicle for a route starting from the starting position to the point A (a zone illustrated by a solid line) is more than or equal to a fatigue level in a route starting from the starting position to the risky point indicated by the risk information of the server 10, the presentation determination unit 25 receives the risk information from the server 10 via the communication unit 21.

In step ST14, when the host vehicle arrives at a point B which is located back from the risky point, of the risk information acquired from the server 10, by a predetermined distance Y (e.g. 100 m), the presentation determination unit 25 acquires the latest driving condition information from the driving condition estimator 23 and determines whether to present the risk information. For example, the distance Y is such a distance that risk information on the risky point can be presented before a predetermined time (for example, 3.2 seconds) from the time indicating when the host vehicle reaches the risky point. The distance Y may be changed to a distance that can secure the predetermined time in accordance with a speed of the host vehicle. Since there is the possibility that the fatigue level of the driver changes while the host vehicle travels in a zone indicated by a broken line in FIG. 15, that is, a zone starting from the point A where the risk information is acquired from the server 10 to the point B which is the current location, the presentation determination unit 25 compares the driving condition information included in the risk information, with the latest driving condition information generated by the driving condition estimator 23 in the zone indicated by the solid line and the broken line in FIG. 15 again in step ST14.

If the estimated fatigue level of the driver in the vehicle in the route starting from the starting position to the point B is higher than or equal to the fatigue level indicated by the risk information acquired from the server 10 (“YES” in step ST14), the presentation determination unit 25 determines to present the risk information and proceeds to step ST15, and then presents the risk information to the driver through the display 31 or the speaker 32. On the other hand, if the fatigue level of the driver in the host vehicle is less than the fatigue level indicated by the risk information acquired from the server 10 (“NO” in step ST14), the presentation determination unit 25 executes step ST14 again. It is assumed that the condition for terminating the repetition of step ST14 is that a distance from the host vehicle to the risky point has become shorter than the distance Y at which the risk information can be presented before the aforementioned predetermined time (for example, 3.2 seconds). When the condition for terminating the repetition of step ST14 is satisfied, the presentation determination unit 25 returns to step ST11.

Note that, in FIGS. 13 to 15, the example in which the driving condition estimator 23 estimates the fatigue level in the route starting from the starting position to the current location has been described; however, without being limited thereto, the fatigue level may be estimated for a route starting from an area including the starting position (for example, within a range of a radius of 1 km including the starting position) to the current location or a route starting from a point located a predetermined distance (for example, 10 km) back from the current location in a traveling direction, to the current location. Providing a certain range to position information as an area including a starting position rather than the starting position enables sharing risk information among more vehicles.

Furthermore, by allowing position information to have a certain margin as an area including a destination (for example, within a radius of 1 km including the destination) rather than the destination, risk information can be shared among more vehicles having the same type of destination.

Moreover, in FIG. 14, comparison of the fatigue levels is performed twice in steps ST12 and ST14; however, this may be performed only once in either of the steps.

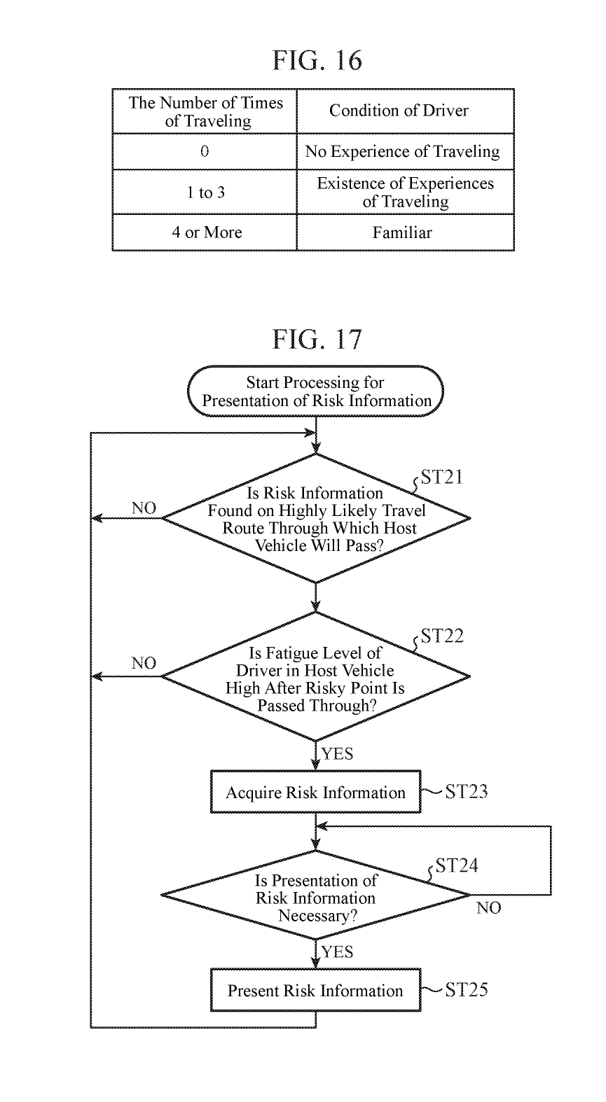

Furthermore, the number of times of traveling of the route may be taken into account in presentation determination of the risk information. For example, as illustrated in FIG. 16, condition of a driver is classified into three categories on the basis of the number of traveling such as the number of traveling in a route counted as zero as “never traveled”, that counted as one to three times as “having traveled”, and that counted as four or more times as “familiar”. Drivers who have never traveled on the route may not be able to drive with the same feeling as usual due to anxiety or tension and may take risky behavior. Conversely, drivers who are familiar with the route are aware of a risky point of the route but may take risky behavior due to lack of concentration caused by familiarity or excessive confidence at other points. In this manner, it is assumed that the points to be noticed are different between drivers who have never traveled on the route in the past and the drivers who are sufficiently familiar to traveling on the route. Therefore, the presentation determination unit 25 determines to present only risk information classified into a category of the same number of times of traveling as that of the driver in the host vehicle to the driver while determining not to present risk information of which a category of the number of times of traveling is different. This allows risk information depending on driving experience to be presented.

Specifically, when recording risk information of the host vehicle in the server 10 in step ST4 of FIG. 13, the risk information generator 24 uses the past travel history information stored in the travel history storage 27 to calculate the number of times of traveling on a route currently traveling on and include the number of times of traveling in the risk information.

When acquiring, from the server 10, risk information indicating a risky point on a highly likely travel route through which the vehicle will pass in the future in step ST11 or step ST13 of FIG. 14, the presentation determination unit 25 acquires only risk information classified into a category having the same number of times of traveling as that of the driver in the host vehicle, and determines whether to present the risk information in step ST12 or step ST14. On the other hand, the presentation determination unit 25 does not acquire risk information classified into categories having the number of times of traveling different from that of the driver in the host vehicle, and also does not present the risk information.

Also, in determining the presentation of risk information, the characteristic condition of the host vehicle or driver may be taken into consideration like the number of times of traveling. For example, when recording the risk information of the host vehicle in the server 10 in step ST4 of FIG. 13, if characteristic condition as illustrated in FIG. 11 is detected on the basis of biological information or vehicle information from the sensor 30, the risk information generator 24 includes information indicating the characteristic condition in the risk information.

When acquiring, from the server 10, risk information indicating a risky point on a highly likely travel route through which the host vehicle will pass in the future in step ST11 or step ST13 of FIG. 14, the presentation determination unit 25 acquires only risk information having the same characteristic condition as that of the host vehicle or the driver, and determines whether to present the risk information in step ST12 or step ST14. On the other hand, the presentation determination unit 25 does not acquire nor present risk information having different characteristic condition from that of the host vehicle or the driver. This enables the presentation of risk information conforming to the characteristic condition, for example, the presentation of risk information on a risky point where a driver is likely to take risky behavior when the driver feels sleepy.

As described above, according to the first embodiment, the driving assistance apparatus 20 includes: the driving condition estimator 23 configured to estimate a condition of a driver in a host vehicle and to generate driving condition information; the risk information generator 24 configured to detect risky behavior taken by the driver, and to generate risk information in which a risky point at which the risky behavior is detected is associated with driving condition information that is generated by the driving condition estimator 23 in a prescribed zone located back from a risky point; the communication unit 21 configured to transmit the risk information generated by the risk information generator 24 to the server 10, and to receive, from the server 10, risk information indicating a risky point on a route on which the host vehicle is planned to travel; and the presentation determination unit 25 configured to compare the driving condition information, of the risk information received by the communication unit 21, generated by the driving condition estimator 23 in the prescribed zone located back from the risky point of the risk information, with the driving condition information included in the risk information, thereby to determine whether to present the risk information. Therefore, whether to present the risk information can be accurately determined in consideration of the condition of the driver traveling on a route before the risky point is reached.

Furthermore, according to the first embodiment, the driving condition estimator 23 estimates a fatigue level of the driver on the basis of a duration of driving time in the prescribed zone located back from the risky point in the traveling direction, as the driving condition information to be used by the presentation determination unit 25 for the determination of presentation or non-presentation, and generates driving condition information including the estimated fatigue level, and further corrects the estimated fatigue level on the basis of at least one of: driving operation performed in the zone; biological information of the driver; vehicle information of the host vehicle detected by the sensor 30 in the zone; and the road type in the zone. Therefore, it is possible to estimate the fatigue level of the driver with high accuracy while the driver travels on a route to a risky point. Consequently, it is possible to more accurately determine whether to present risk information.

Furthermore, according to the first embodiment, the driving condition estimator 23 corrects the fatigue level of the driver on the basis of the type of destination of the host vehicle. Therefore, it is possible to determine whether to present risk information with further high accuracy. Note that the driving condition estimator 23 may estimate the type of destination of the host vehicle on the basis of travel history and calendar information of the host vehicle.

Furthermore, according to the first embodiment, the risk information generator 24 calculates the number of times the host vehicle has traveled in the past in the prescribed zone located back in the traveling direction from the risky point where the risky behavior has been detected, on the basis of the travel history of the host vehicle, and includes the number of times in the risk information. The presentation determination unit 25 compares the number of times of traveling included in the risk information received by the communication unit 21 from the server 10, with the number of times of traveling in the past of the host vehicle in the prescribed zone located back in the traveling direction from the risky point of the risk information, thereby to determine whether to present the risk information. Therefore, it is possible to present risk information depending on driving experience.

### Second Embodiment

In the first embodiment, whether to present risk information is determined in consideration of the condition of the driver traveling on the route to the risky point. In contrast, in a second embodiment, whether to present risk information is determined in consideration of the condition of a driver traveling on a route located beyond a risky point.

Note that, since the configurations of a server 10 and a driving assistance apparatus 20 in the second embodiment are the same as the configurations as illustrated in FIG. 1 in the first embodiment, in view of the drawings, the following descriptions will be made with reference to FIG. 1.

In the second embodiment, a driving condition estimator 23 of the driving assistance apparatus 20 estimates the fatigue level of a driver in a prescribed zone located beyond the current location in the traveling direction and generates driving condition information. The prescribed zone includes a route starting from the current location to a destination, a route starting from the current location to an area including the destination (for example, within a radius of 1 km including the destination), or a route starting from the current location to a point a predetermined distance away therefrom in a traveling direction (for example, 10 km).

For example, the driving condition estimator 23 estimates a duration of driving time for traveling in a prescribed zone located beyond the current location in the traveling direction using travel route information stored in a travel route storage 28 or other information and estimates the fatigue level of a driver on the basis of the estimated a duration of driving time and the fatigue curve as illustrated in the above-described FIG. 3.

A method of estimating a duration of driving time may be any method. For example, time required for traveling in the prescribed zone located beyond the current location in the traveling direction while an average vehicle speed in a certain period of time is maintained may be calculated as a duration of driving time. Alternatively, time required for traveling in the prescribed zone located beyond the current location in the traveling direction complying with a speed limit included in the map information of the map DB 26 may be calculated as a duration of driving time.

Furthermore, the driving condition estimator 23 may correct the estimated fatigue level of the driver. As a correction method, at least one of a method using driving operation performed in a certain zone and a method using the road type in a certain zone or the type of destination is to be employed.

For example, using travel route information in a travel route storage 28 and map information in a map DB 26, the driving condition estimator 23 determines driving operation expected to be performed in a prescribed zone located beyond the current location in a traveling direction and corrects the fatigue level by adding, to the fatigue level, the additional values corresponding to the driving operation as illustrated in FIG. 9.

In addition, for example, the driving condition estimator 23 determines the road type in the prescribed zone located beyond the current location in the traveling direction, using the travel route information in the travel route storage 28 and the map information in the map DB 26, and corrects the fatigue level by weighting, in accordance with the road type as illustrated in FIGS. 10A to 10C.

In addition, for example, the driving condition estimator 23 estimates the type of destination using travel history information in a travel history storage 27 and calendar information and corrects the fatigue level by performing weighting in accordance with the type of destination illustrated in FIG. 12.

In the second embodiment, a risk information generator 24 associates driving condition information that is generated by the driving condition estimator 23 in a prescribed zone located beyond the risky point where the risky behavior has been detected in the traveling direction, with the risky point together with contents of the risky behavior, thereby generating risk information. Then, the risk information generator 24 transmits the generated risk information to the server 10 via a communication unit 21.

In the second embodiment, a presentation determination unit 25 compares a fatigue level of driving condition information included in risk information received by a communication unit 21 from the server 10, with a fatigue level of driving condition information that is generated by the driving condition estimator 23 in a prescribed zone located beyond the risky point in the traveling direction, indicated by the risk information. In a case where the fatigue level of the driving condition information generated by the driving condition estimator 23 is higher than or equal to the fatigue level of the driving condition information included in the risk information, this risk information is determined as information to be presented.

Like in the first embodiment, also in the second embodiment the presentation determination unit 25 may acquire from the server 10 only the risk information in which the number of times of traveling or a characteristic condition is the same as that of a host vehicle.

Here, processing for presentation of the risk information in the driving assistance apparatus 20 will be described.

FIG. 17 is a flowchart illustrating the processing for presentation of risk information in the driving assistance apparatus 20 according to the second embodiment. While the host vehicle is traveling, the driving assistance apparatus 20 repeatedly performs the processing as illustrated in the flowchart of FIG. 17. It is assumed that, in addition to the processing as illustrated in the flowchart of FIG. 17, the driving assistance apparatus 20 generates the driving condition information and records risk information.

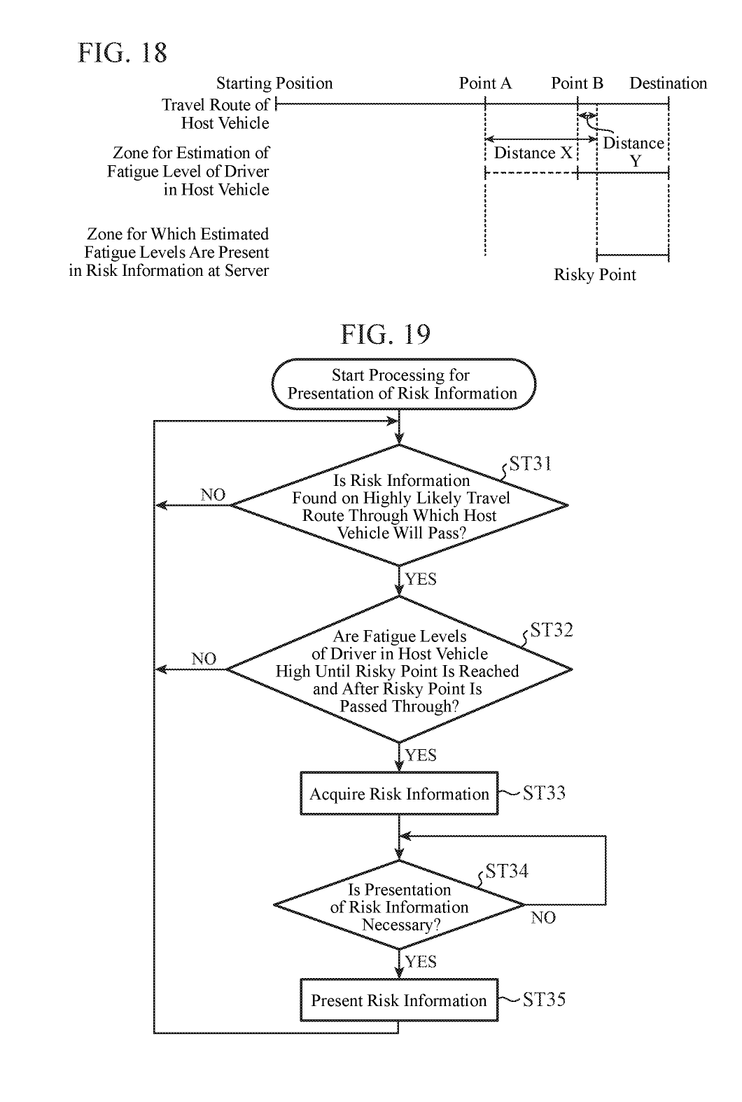

FIG. 18 is a graph for explaining the processing for presentation of risk information in the driving assistance apparatus 20 according to the second embodiment, and illustrates, in order from top to bottom, a travel route of the host vehicle, a zone for estimation of the fatigue level of a driver in the host vehicle in the driving condition estimator 23, and a zone for which the estimated fatigue levels are present in risk information recorded in the server 10.

In step ST21, the presentation determination unit 25 accesses the server 10 via the communication unit 21, and determines whether risk information indicating a risky point on a highly likely travel route through which the host vehicle will pass in the future, or a route similar to the travel route, is recorded in a risk information DB 12 of the server 10.

If the server 10 stores the recorded risk information that indicates the same traveling direction and indicates a risky point on the highly likely travel route through which the host vehicle will pass in the future (“YES” in step ST21), the presentation determination unit 25 proceeds to step ST22. On the other hand, if risk information conforming to the above conditions is not recorded in the server 10 (“NO” in step ST21), the presentation determination unit 25 executes step ST21 again.

In the example illustrated in FIG. 18, the presentation determination unit 25 determines whether the server 10 stores the recorded risk information that indicates a risky point on a travel route within a distance X (e.g. 10 km) beyond from a point A representing a reference in the traveling direction when the host vehicle is traveling at the point A. It is also assumed that risk information recorded in the server 10 includes driving condition information, indicating the estimated fatigue level in a route starting from a risky point to a destination.

In step ST22, the presentation determination unit 25 compares driving condition information included in risk information conforming to the aforementioned conditions recorded in the server 10 with driving condition information generated by the driving condition estimator 23.

If a fatigue level of a driver in the host vehicle is higher than or equal to a fatigue level indicated by the risk information of the server 10 (“YES” in step ST22), the presentation determination unit 25 proceeds to step ST23 and acquires all information included in the risk information from the server 10. On the other hand, if a fatigue level of a driver in the host vehicle is less than the fatigue level indicated by the risk information of the server 10 (“NO” in step ST22), the presentation determination unit 25 returns to step ST21.

In the example illustrated in FIG. 18, in a case where a fatigue level of the driver in the host vehicle estimated for a route starting from the point A to the destination (a zone illustrated by a broken line and a solid line) is more than or equal to a fatigue level in a route starting from the risky point to the destination indicated by the risk information of the server 10, the presentation determination unit 25 receives the risk information from the server 10 via the communication unit 21.

In step ST24, when the host vehicle arrives at a point B which is located back from the risky point of the risk information acquired from the server 10, by a predetermined distance Y (e.g. 100 m), the presentation determination unit 25 acquires the latest driving condition information from the driving condition estimator 23 and determines whether to present the risk information. by traveling in a zone indicated by a broken line in FIG. 18, that is, in a zone starting from the point A where the risk information has been acquired from the server 10, to the point B indicating the current location, a duration of driving time to a destination as a basis of estimation of the fatigue level is changed. So, the presentation determination unit 25 compares the driving condition information included in the risk information, with the latest driving condition information that is generated by the driving condition estimator 23 in the zone indicated by the solid line in FIG. 18 again in step ST24.

If the estimated fatigue level of the driver in the host vehicle in the route starting from the point B to the destination is higher than or equal to the fatigue level indicated by the risk information acquired from the server 10 (“YES” in step ST24), the presentation determination unit 25 determines the presentation of the risk information and proceeds to step ST25, and then presents the risk information to the driver through the display 31 or the speaker 32. On the other hand, if the fatigue level of the driver in the host vehicle is less than the fatigue level indicated by the risk information acquired from the server 10 (“NO” in step ST24), the presentation determination unit 25 executes step ST24 again and returns to step ST21 if the condition for termination is satisfied.

Note that, in FIGS. 17 and 18, the example in which the driving condition estimator 23 estimates the fatigue level in the route starting from the current location to the destination has been described; however, without being limited thereto, the fatigue level may be estimated for a route starting from the current location to an area including the destination (for example, within a range of a radius of 1 km including the destination) or a route starting from the current location to a point located a predetermined distance (for example, 10 km) beyond from the current location in a traveling direction.

By allowing position information to have a certain margin as a destination area rather than the destination, risk information can be shared among more vehicles, and risk information can be shared among more vehicles having the same type of destination.

Moreover, in FIG. 17, comparison of the fatigue levels is performed twice in steps ST22 and ST24; however, this may be performed only once in either of the steps.

As described above, according to the second embodiment, the driving assistance apparatus 20 includes: the driving condition estimator 23 configured to estimate a condition of a driver in a host vehicle, and to generate driving condition information; the risk information generator 24 configured to detect risky behavior taken by the driver, and to generate risk information in which a risky point at which the risky behavior has been detected is associated with driving condition information that is generated by the driving condition estimator 23 in a prescribed zone located beyond the risky point in a traveling direction; the communication unit 21 configured to transmit the risk information generated by the risk information generator 24 to the server, and to receive, from the server 10, risk information indicating a risky point on a route on which the host vehicle is planned to travel; and the presentation determination unit 25 configured to compare the driving condition information, of the risk information received by the communication unit 21, generated by the driving condition estimator 23 in the prescribed zone located beyond the risky point, with the driving condition information included in the risk information, thereby to determine whether to present the risk information. Therefore, whether to present the risk information can be accurately determined in consideration of the condition of the driver traveling on a route located beyond the risky point.

Furthermore, according to the second embodiment, the driving condition estimator 23 estimates a fatigue level of the driver on the basis of a duration of driving time in the prescribed zone located beyond the risky point in the traveling direction, as the driving condition information to be used by the presentation determination unit 25 for the determination of presentation or non-presentation, and generates driving condition information including the estimated fatigue level, and further corrects the estimated fatigue level on the basis of at least one of driving operation estimated in the zone and the road type in the zone. Therefore, it is possible to estimate the fatigue level of the driver with high accuracy while the driver travels on a route located beyond a risky point. Consequently, it is possible to more accurately determine whether to present risk information

Furthermore, according to the second embodiment, the driving condition estimator 23 corrects the fatigue level of the driver on the basis of the type of destination of the host vehicle. Therefore, it is possible to determine whether to present risk information with high accuracy. Note that the driving condition estimator 23 may estimate the type of destination of the host vehicle on the basis of travel history and calendar information of the host vehicle.

Furthermore, like in the first embodiment, also in the second embodiment the number of times of traveling of the route may be taken into account in presentation determination of the risk information.

Specifically, the risk information generator 24 calculates the number of times the host vehicle has traveled in the past in the prescribed zone located, in the traveling direction, beyond the risky point where the risky behavior has been detected, on the basis of travel history of the host vehicle, and include the number of times of traveling in the risk information.

The presentation determination unit 25 determines whether to present the risk information on the basis of the driving condition information, if both the number of times of traveling included in the risk information received by the communication unit 21 from the server 10 and the number of times of traveling in the past of the host vehicle in the prescribed zone located in the traveling direction beyond the risky point of the risk information belong to the category having the same number of times of traveling. The presentation determination unit 25 determines the non-presentation of the risk information if categories of the number of times of traveling are different. This allows risk information depending on driving experience to be presented.

### Third Embodiment

In the first and second embodiments, whether to present the risk information is determined in consideration of the condition of the driver traveling on one of the route to the risky point or the route located beyond the risky point. In contrast, in a third embodiment, whether to present risk information is determined in consideration of the condition of a driver traveling on both a route to a risky point and a route located beyond the risky point.

Note that, since the configurations of a server 10 and a driving assistance apparatus 20 in the third embodiment are the same as the configurations as illustrated in FIG. 1 in the first embodiment, in view of the drawings, the following descriptions will be made with reference to FIG. 1.

In the third embodiment, a driving condition estimator 23 of the driving assistance apparatus 20 estimates the fatigue levels of a driver in a prescribed zone located back from the current location in a traveling direction and in a prescribed zone located beyond the current location in the traveling direction, and generates driving condition information. A method of estimating the fatigue level of a driver in a prescribed zone located back from the current location in the traveling direction is as described in the first embodiment. A method of estimating the fatigue level of a driver in a prescribed zone located beyond the current location in a traveling direction is as described in the second embodiment.

In the third embodiment, the risk information generator 24 associates driving condition information that is generated by the driving condition estimator 23 both in a prescribed zone located in a traveling direction back from a risky point where the risky behavior has been detected, and in a prescribed zone located beyond the risky point in the traveling direction, with the risky point together with contents of the risky behavior, thereby to generate risk information. Then, the risk information generator 24 transmits the generated risk information to the server 10 via a communication unit 21.

In the third embodiment, a presentation determination unit 25 compares a fatigue level of driving condition information included in risk information received by a communication unit 21 from the server 10, with a fatigue level of driving condition information that is generated by the driving condition estimator 23 both in a prescribed zone located back in a traveling direction from a risky point indicated by the risk information and in a prescribed zone located beyond the risky point in the traveling direction. In a case where the fatigue level of the driving condition information generated by the driving condition estimator 23 is higher than or equal to the fatigue level of the driving condition information included in the risk information, this risk information is determined as information to be presented.

Like in the first and the second embodiments, also in the third embodiment the presentation determination unit 25 may acquire from the server 10 only risk information in which the number of times of traveling or a characteristic condition is the same as that of the host vehicle.

Next, processing for presentation of the risk information in the driving assistance apparatus 20 will be described.

FIG. 19 is a flowchart for explaining the processing for presentation of risk information in the driving assistance apparatus 20 according to the third embodiment. While the host vehicle is traveling, the driving assistance apparatus 20 repeatedly performs the processing as illustrated in the flowchart of FIG. 19. In addition, it is assumed that the driving assistance apparatus 20 is generating the driving condition information and recording the risk information in parallel with the processing as illustrated in the flowchart of FIG. 19.

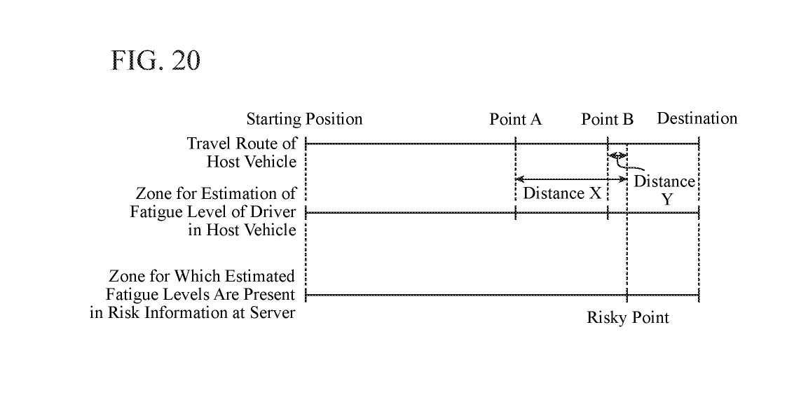

FIG. 20 is a graph for explaining the processing for presentation of risk information in the driving assistance apparatus 20 according to the third embodiment, and illustrates, in order from top to bottom, a travel route of the host vehicle, a zone for estimation of the fatigue level of a driver in the host vehicle in the driving condition estimator 23, and a zone for which the estimated fatigue levels are present in risk information recorded in the server 10.

In step ST31, the presentation determination unit 25 accesses the server 10 via the communication unit 21, and determines whether risk information indicating a risky point on a highly likely travel route through which a host vehicle will pass in the future or a route similar to the travel route is recorded in the risk information DB12 of the server 10.

If the server 10 stores the recorded risk information that indicates the same traveling direction and indicates a risky point on the highly likely travel route through which the host vehicle will pass in the future (“YES” in step ST31), the presentation determination unit 25 proceeds to step ST32. On the other hand, if risk information conforming to the above conditions is not recorded in the server 10 (“NO” in step ST31), the presentation determination unit 25 executes step ST31 again.

In the example illustrated in FIG. 20, the presentation determination unit 25 determines whether risk information indicating a risky point on a travel route within a distance X (e.g. 10 km) beyond from a point A as a reference in the traveling direction is recorded in the server 10 when the host vehicle is traveling at the point A. It is also assumed that risk information recorded in the server 10 includes driving condition information indicating a fatigue level estimated in a route starting from a starting position to a destination.

In step ST32, the presentation determination unit 25 compares driving condition information included in risk information conforming to the aforementioned conditions recorded in the server 10 with driving condition information generated by the driving condition estimator 23.

If a fatigue level of a driver in the host vehicle is higher than or equal to a fatigue level indicated by the risk information of the server 10 (“YES” in step ST32), the presentation determination unit 25 proceeds to step ST33 and acquires all information included in the risk information from the server 10. On the other hand, if a fatigue level of a driver in the host vehicle is less than the fatigue level indicated by the risk information of the server 10 (“NO” in step ST32), the presentation determination unit 25 returns to step ST31.

In the example illustrated in FIG. 20, in a case where a fatigue level of the driver in the host vehicle estimated for a route starting from the starting position to the destination is more than or equal to a fatigue level in a route starting from the starting position to the destination indicated by the risk information of the server 10, the presentation determination unit 25 receives the risk information from the server 10 via the communication unit 21.

In step ST34, when the host vehicle arrives at a point B which is located back from the risky point of the risk information acquired from the server 10, by a predetermined distance Y (e.g. 100 m), the presentation determination unit 25 acquires the latest driving condition information from the driving condition estimator 23 and determines whether to present the risk information. Since a ratio between a zone estimated of the fatigue level from a measured value and a zone estimated the fatigue level from an estimated value changes as a result of traveling in a zone starting from the point A where the risk information has been acquired from the server 10 to the point B which is the current location, the presentation determination unit 25 compares the driving condition information included in the risk information with the latest driving condition information generated by the driving condition estimator 23 at the point B again in step ST34.

If the fatigue level of the driver in the host vehicle estimated in the route starting from the starting position to the destination is higher than or equal to the fatigue level indicated by the risk information acquired from the server 10 (“YES” in step ST34), the presentation determination unit 25 determines to present the risk information and proceeds to step ST35, and then presents the risk information to the driver through the display 31 or the speaker 32. On the other hand, if the fatigue level of the driver in the host vehicle is less than the fatigue level indicated by the risk information acquired from the server 10 (“NO” in step ST34), the presentation determination unit 25 executes step ST34 again and returns to step ST31 if the condition for termination is satisfied.

Note that, in FIGS. 19 and 20, the example in which the driving condition estimator 23 estimates the fatigue level in the route starting from the starting position to the destination has been described; however, without being limited thereto, the fatigue level may be estimated for a route starting from an area including a starting position (for example, within a range of a radius of 1 km including the starting position) to an area including a destination (for example, within a range of a radius of 1 km including the destination) or a route starting from a point located a predetermined distance (for example, 10 km) back from the current location in a traveling direction, to a point located a predetermined distance (for example, 10 km) beyond from the current location in the traveling direction.

Providing a certain range to position information as an area including a starting position and an area including a destination rather than the starting position and the destination enables sharing risk information among more vehicles.

Furthermore, by allowing position information to have a certain margin as an area including a destination rather than the destination, risk information can be shared among more vehicles having the same type of destination.

Moreover, in FIG. 19, comparison of the fatigue levels is performed twice in steps ST32 and ST34; however, this may be performed only once in either of the steps.

As described above, according to the third embodiment, the driving assistance apparatus 20 includes: the driving condition estimator 23 configured to estimate a condition of a driver in a host vehicle and generating driving condition information; the risk information generator 24 configured to detect risky behavior taken by the driver, and to generate risk information in which a risky point at which the risky behavior has been detected is associated with driving condition information that is generated by the driving condition estimator 23 both in a prescribed zone located back in the traveling direction from the risky point, and in a prescribed zone beyond from the risky point in the traveling direction; the communication unit 21 configured to transmit, to the server 10, the risk information generated by the risk information generator 24 and to receive, from the server 10, risk information indicating a risky point on a route on which the host vehicle is planned to travel; and the presentation determination unit 25 configured to compare the driving condition information, of the risk information received by the communication unit 21, generated by the driving condition estimator 23 both in the prescribed zone located back from the risky point in the traveling direction and in a prescribed zone located beyond the risky point in the traveling direction, with the driving condition information included in the risk information, thereby to determine whether to present the risk information. Therefore, whether to present the risk information can be accurately determined in consideration of the condition of the driver traveling both on a route before the risky point is reached, and on a route located beyond the risky point.

Furthermore, according to the third embodiment, the driving condition estimator 23 estimates a fatigue level of the driver on the basis of a duration of driving time in the prescribed zone located beyond the risky point in the traveling direction and a duration of driving time estimated in the prescribed zone located beyond the risky point in the traveling direction, as the driving condition information to be used by the presentation determination unit 25 for the determination of presentation or non-presentation, and further generates driving condition information including the estimated fatigue level. Furthermore, the driving condition estimator 23 corrects the fatigue level on the basis of at least one of driving operation performed in the prescribed zone located back from the risky point in the traveling direction, biological information of the driver, vehicle information of the host vehicle, and the road type, or corrects the fatigue level on the basis of at least one of driving operation predicted in the prescribed zone located beyond the risky point in the traveling direction, and the road type. It is thus possible to highly accurately estimate the fatigue level of the driver traveling on the route to the risky point and the route located beyond the risky point. Therefore, it is possible to more accurately determine whether to present risk information

Furthermore, according to the third embodiment, the driving condition estimator 23 corrects the fatigue level of the driver on the basis of the type of destination of the host vehicle. Therefore, it is possible to determine whether to present risk information with high accuracy. Note that the driving condition estimator 23 may estimate the type of destination of the host vehicle on the basis of travel history and calendar information of the host vehicle.

Furthermore, like in the first embodiment and the second embodiments, also in the third embodiment the number of times of traveling of the route may be taken into account in presentation determination of the risk information.

Specifically, the risk information generator 24 calculates at least one of the number of times the host vehicle has traveled in the past in the prescribed zone located back in the traveling direction from the risky point where the risky behavior has been detected, and the number of times the host vehicle has traveled in the past in the prescribed zone located beyond the risky point in the traveling direction, on the basis of travel history of the host vehicle, and further include the calculated number of times of traveling in the risk information.

The presentation determination unit 25 determines whether to present the risk information, on the basis of the driving condition information, if the number of times of traveling included in the risk information received by the communication unit 21 from the server 10, and at least one of the number of times the host vehicle has traveled in the past in the prescribed zone located back in the traveling direction from the risky point of the risk information and the number of times the host vehicle has traveled in the past in the prescribed zone located beyond the risky point in the traveling direction, belong to the category having the same number of times of traveling. The presentation determination unit 25 determines the non-presentation of the risk information if categories of the number of times of traveling are different. This allows risk information depending on driving experience to be presented.

Note that, within the scope of the present invention, the present invention may include a flexible combination of the respective embodiments, a modification of any component of the respective embodiments, or omission of any component in the respective embodiments.

### INDUSTRIAL APPLICABILITY

In a driving assistance apparatus according to the invention, only risk information appropriate for a driver is presented out of risk information recorded in a server and thus is suitable for use as a driving assistance apparatus for presenting information of points requiring attention to driving to the driver.

### REFERENCE SIGNS LIST

10: Server; 11: Communication unit; 12: risk information DB; 13: controller; 20: driving assistance apparatus; 21: Communication unit; 22: controller; 23: Driving condition estimator; 24: risk information generator; 25: Presentation determination unit; 26: Map DB; 27: Travel history storage; 28: Travel route storage; 30: Sensor; 31: Display; 32: Speaker; 201: Communication device; 202: CPU; and 203: Memory.

1. A driving assistance apparatus, comprising:
a driving condition estimator to estimate a condition of a driver in a host vehicle to generate driving condition information;
a risk information generator to detect risky behavior taken by the driver, and to generate risk information in which a risky point at which the risky behavior is detected is associated with driving condition information that is generated by the driving condition estimator in a prescribed zone located back from the risky point in a traveling direction;
a communication unit to transmit the risk information generated by the risk information generator to a server to cause the server to record the generated risk information as recorded risk information, and to receive, from the server, recorded risk information indicating a risky point on a route on which the host vehicle is planned to travel; and
a presentation determination unit to compare driving condition information generated by the driving condition estimator in a prescribed zone located back in a traveling direction from a risky point of the recorded risk information received by the communication unit, with driving condition information included in the recorded risk information received by the communication unit, thereby to determine whether to present the recorded risk information received by the communication unit.

2. (canceled)

3. The driving assistance apparatus according to claim 1, wherein the driving condition estimator estimates a fatigue level of the driver on a basis of a duration of driving time in the prescribed zone located back from the risky point in a traveling direction, and generates information including the estimated fatigue level, as the driving condition information.

4. The driving assistance apparatus according to claim 3, wherein the driving condition estimator corrects the estimated fatigue level on a basis of at least one of: driving operation performed in the prescribed zone located back from the risky point in a traveling direction; biological information of the driver; vehicle information of the host vehicle detected by a sensor in the zone; and a road type in the zone.

5. The driving assistance apparatus according to claim 3, wherein the driving condition estimator corrects the estimated fatigue level on a basis of a type of destination of the host vehicle.

6. The driving assistance apparatus according to claim 5, wherein the driving condition estimator estimates the type of destination of the host vehicle on a basis of travel history and calendar information of the host vehicle.

7. A driving assistance apparatus, comprising:
a driving condition estimator to estimate a condition of a driver in a host vehicle to generate driving condition information;
a risk information generator to detect risky behavior taken by the driver, and to generate risk information in which a risky point at which the risky behavior is detected is associated with driving condition information that is generated by the driving condition estimator in a prescribed zone located beyond the risky point in a traveling direction;
a communication unit to transmit the risk information generated by the risk information generator to a server to cause the server to record the generated risk information as recorded risk information, and to receive, from the server, recorded risk information indicating a risky point on a route on which the host vehicle is planned to travel; and
a presentation determination unit to determine whether to present the recorded risk information received by the communication unit, wherein
the driving condition estimator estimates driving condition information in a prescribed zone located in a traveling direction beyond a risky point of the recorded risk information received by the communication unit, when the vehicle travels on a route to the risky point of the recorded risk information received by the communication unit, and
the presentation determination unit compares the estimated driving condition information with driving condition information included in the recorded risk information received by the communication unit, thereby to determine whether to present the recorded risk information received by the communication unit.

8. The driving assistance apparatus according to claim 7, wherein the driving condition estimator estimates a fatigue level of the driver on a basis of a predicted duration of driving time estimated in the prescribed zone located beyond a risky point, in a traveling direction, of the recorded risk information received by the communication unit, and generates information including the estimated fatigue level, as the estimated driving condition information.

9. The driving assistance apparatus according to claim 8, wherein the driving condition estimator corrects the estimated fatigue level on a basis of at least one of: predicted driving operation in the prescribed zone located beyond the risky point, in a traveling direction, of the recorded risk information received by the communication unit; and a road type in the zone.

10. The driving assistance apparatus according to claim 8, wherein the driving condition estimator corrects the estimated fatigue level on a basis of a type of destination of the host vehicle.

11. The driving assistance apparatus according to claim 10, wherein the driving condition estimator estimates the type of destination of the host vehicle on a basis of travel history and calendar information of the host vehicle.

12. A driving assistance apparatus, comprising:
a driving condition estimator to estimate a condition of a driver in a host vehicle to generate driving condition information:
a risk information generator to detect risky behavior taken by the driver, and to generate risk information in which a risky point at which the risky behavior is detected is associated with driving condition information that is generated by the driving condition estimator in both a prescribed zone located back from the risky point in a traveling direction and a prescribed zone located beyond the risky point in a traveling direction;
a communication unit to transmit the risk information generated by the risk information generator to a server to cause the server to record the generated risk information as recorded risk information, and to receive, from the server, recorded risk information indicating a risky point on a route on which the host vehicle is planned to travel; and
a presentation determination unit to determine whether to present the recorded risk information received by the communication unit, wherein
the driving condition estimator generates first driving condition information in a prescribed first zone located back in a traveling direction from a risky point of the recorded risk information received by the communication unit, and estimates second driving condition information in a prescribed second zone located in a traveling direction beyond the risky point of the recorded risk information received by the communication unit, when the vehicle travels on a route to the risky point of the recorded risk information received by the communication unit, and
the presentation determination unit compares the first and second driving condition information with driving condition information included in the recorded risk information received by the communication unit, thereby to determine whether to present the recorded risk information received by the communication unit.

13. The driving assistance apparatus according to claim 12, wherein the driving condition estimator estimates a fatigue level of the driver on a basis of both a duration of driving time in the prescribed first zone and a predicted duration of driving time in the prescribed second zone, and generates information including the estimated fatigue level, as the estimated second driving condition information.

14. The driving assistance apparatus according to claim 13, wherein the driving condition estimator corrects the estimated fatigue level on a basis of at least one of: driving operation performed in the prescribed first zone; biological information of the driver; vehicle information of the host vehicle detected by a sensor in the prescribed first zone; and a road type in the prescribed first zone.

15. The driving assistance apparatus according to claim 13, wherein the driving condition estimator corrects the estimated fatigue level on a basis of at least one of: predicted driving operation in the prescribed second zone; and a road type in the prescribed second zone.

16. The driving assistance apparatus according to claim 13, wherein the driving condition estimator corrects the estimated fatigue level on a basis of a type of destination of the host vehicle.

17. The driving assistance apparatus according to claim 16, wherein the driving condition estimator estimates the type of destination of the host vehicle on a basis of travel history and calendar information of the host vehicle.

18. The driving assistance apparatus according to claim 1, wherein:
the risk information generator calculates the number of times of traveling when the host vehicle has already traveled in the prescribed zone located back in a traveling direction from the risky point at which the risky behavior has been detected, on a basis of travel history of the host vehicle, and includes said number of times of traveling in the risk information; and
the presentation determination unit compares the number of times of traveling included in the risk information received by the communication unit, with the number of times of traveling obtained when the host vehicle has already traveled in the prescribed zone located back in a traveling direction from the risky point of the recorded risk information received by the communication unit, thereby to determine whether to present the recorded risk information received by the communication unit.

19. The driving assistance apparatus according to claim 7, wherein:
the risk information generator calculates the number of times of traveling when the host vehicle has already traveled in the prescribed zone located beyond the risky point in a traveling direction at which the risky behavior has been detected, on a basis of travel history of the host vehicle, and includes said number of times of traveling in the risk information; and
the presentation determination unit compares the number of times of traveling included in the recorded risk information received by the communication unit, with the number of times of traveling obtained when the host vehicle has already traveled in the prescribed zone located in a traveling direction beyond the risky point of the recorded risk information received by the communication unit, thereby to determine whether to present the recorded risk information received by the communication unit.

20. A driving assistance apparatus, comprising:
driving-condition estimation circuitry configured to estimate a condition of a driver in a host vehicle to generate driving condition information;
risk-information generation circuitry configured to detect risky behavior taken by the driver, and configured to generate risk information in which a risky point at which the risky behavior is detected is associated with driving condition information that is generated by the driving-condition estimation circuitry in a prescribed zone located back from the risky point in a traveling direction;
communication circuitry configured to transmit the risk information generated by the risk-information generation circuitry to a server to cause the server to record the generated risk information as recorded risk information, and to receive, from the server, recorded risk information indicating a risky point on a route on which the host vehicle is planned to travel; and
presentation determination circuitry configured to compare driving condition information generated by the driving-condition estimation circuitry in a prescribed zone located back in a traveling direction from a risky point of the recorded risk information received by the communication circuitry, with driving condition information included in the recorded risk information received by the communication circuitry, thereby to determine whether to present the recorded risk information received by the communication circuitry.

21. A driving assistance apparatus, comprising:
driving-condition estimation circuitry configured to estimate a condition of a driver in a host vehicle to generate driving condition information;
risk-information generation circuitry configured to detect risky behavior taken by the driver, and to generate risk information in which a risky point at which the risky behavior is detected is associated with driving condition information that is generated by the driving-condition estimation circuitry in a prescribed zone located beyond the risky point in a traveling direction;
communication circuitry configured to transmit the risk information generated by the risk-information generation circuitry to a server to cause the server to record the generated risk information as recorded risk information, and configured to receive, from the server, recorded risk information indicating a risky point on a route on which the host vehicle is planned to travel; and
presentation determination circuitry configured to determine whether to present the recorded risk information received by the communication circuitry, wherein
the driving-condition estimation circuitry estimates driving condition information in a prescribed zone located in a traveling direction beyond a risky point of the recorded risk information received by the communication circuitry, when the vehicle travels on a route to the risky point of the recorded risk information received by the communication circuitry, and
the presentation determination circuitry compares the estimated driving condition information with driving condition information included in the recorded risk information received by the communication circuitry, thereby to determine whether to present the recorded risk information received by the communication circuitry.
